(19) United States
(12) Patent Application Publication
(10) Pub. No.: US 2006/0117272 A1
(43) Pub. Date: Jun. 1, 2006

(54) Display and display program

(75) Inventors: Shigeru Sawada, Osaka (JP); Yoshikazu Mihara, Kawanishi-city (JP); Masashi Fujita, Osaka (JP); Ryosuke Ohtsuki, Osaka (JP); Yoshikazu Kita, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-city (JP)

(21) Appl. No.: 11/288,354

(22) Filed: Nov. 29, 2005

(30) Foreign Application Priority Data
Nov. 30, 2004 (JP) P2004-346713

(51) Int. Cl. G06F 17/00; G06F 17/21; G06F 17/24

(52) U.S. Cl. 715/802; 715/517; 715/501.1

(57) ABSTRACT

A WebTV (a WebTV main unit) has: a display controller for displaying a Web page including a plurality of link information in which a linked page is set and which is divided into a plurality of areas on a display unit; an area switcher for inputting an area switching command for switching an active area which is an area in a state where a user can select into the display controller; and a link switcher for inputting a link information switching command for switching active link information which is link information in a state where the user can select in the active area into the display controller based on a link information switching signal.

### CROSS REFERENCE TO RELATED APPLICATIONS

This application is based upon and claims the benefit of priority from the prior Japanese Patent Applications No. P2004-346713, filed on Nov. 30, 2004; the entire contents of which are incorporated herein by reference.

### BACKGROUND OF THE INVENTION

1. Field of the Invention

The present invention relates to a display for displaying a page including a plurality of pieces of link information on a predetermined viewing area, and to a display program thereof.

2. Description of the Related Art

Conventionally, a terminal (for example, a personal computer) having a receiver for receiving information generated in accordance with a markup language such as HTML (hereinafter, referred to as the HTML information) from a network side and a Web browser which is software for displaying a Web page based on the received HTML information has been broadly known.

A Web page includes link information in which other Web pages are set as a linked page. A user selects link information, thus making it possible to browse other Web pages corresponding to the selected link information.

A television having a function of playing video contents delivered from a broadcasting station together with a function of displaying a Web page, by incorporating a Web browser (hereinafter, referred to as the WebTV) is also known. Note that although the WebTV is generally provided with a remote controller for switching broadcasting channels, a pointing device such as a mouse is not provided therewith.

Therefore, the user presses buttons provided on the remote controller (for example, up, down, left and right buttons) to switch link information in a selectable state, i.e., in an active state (for example, highlighted link information). In this manner, the user has to switch the target link information to the selectable state.

In other words, in the conventional WebTV, the user is required to switch the link information in the selectable state one by one. Therefore, the operation of selecting the link information using the remote controller is more complicated than that of selecting the link information using the pointing device such as the mouse.

On the other hand, another WebTV has also been proposed (for example, Japanese Patent Application Laid-open No. H10-98654 (claim 1 and paragraphs 23 and 24). It is possible with the WebTV to easily select the target link information using the remote controller by associating the link information included in the Web page with the buttons provided on the remote controller.

### BRIEF SUMMARY OF THE INVENTION

Incidentally, there is a case where not all link information included in the Web page is displayed in the viewing area of the WebTV when the Web page is larger than the viewing area of the WebTV. That is, there is a case where the target link information is not displayed unless the Web page is scrolled on the viewing area of the WebTV.

In such a case, by pressing the buttons provided on the remote controller, the user scrolls the Web page little by little on the viewing area of the WebTV in order to search for the target link information. Accordingly, further improvement is desired.

The present invention has been made to solve the above problem, and an object of the present invention is therefore to provide a display which can make a user easily select link information included in a page even if a pointing device such as a mouse is not provided, and to provide a display program thereof.

According to an aspect of the present invention, the display is provided with a display controller, an area switcher and a link information switcher. The display controller displays a page including a plurality of link information in which a linked page is set and which is divided into a plurality of areas on a predetermined viewing area. The area switcher switches an active area which is the area in a state that the user can select, based on an area switching signal. The link information switcher switches an active link information which is link information in a state that the user can select in the active area, based on a link information switching signal.

Further, according to another aspect of the present invention, a display program causes a computer to execute the steps of: displaying a page including a plurality of link information in which a linked page is set and which is divided into a plurality of areas on a predetermined viewing area; switching an active area, which is the area in a state that a user can select, based on an area switching signal; and switching an active link information which is link information in a state that the user can select in the active area, based on a link information signal.

### BRIEF DESCRIPTION OF THE DRAWINGS

FIGS. 1A and 1B are views showing a display according to an embodiment of the present invention.

FIG. 2 is a functional block diagram showing a WebTV main unit according to the embodiment of the present invention.

FIG. 3 is a view showing an example of a Web page displayed on a display unit according to the embodiment of the present invention (first).

FIG. 4 is a view showing an example of the Web page displayed on the display unit according to the embodiment of the present invention (second).

FIG. 5 is a view showing an example of the Web page displayed on the display unit according to the embodiment of the present invention (third).

FIG. 6 is a view showing an example of a Web page displayed on the display unit according to a modification example of the present invention (first).

FIG. 7 is a view showing an example of a Web page displayed on the display unit according to a modification example of the present invention (second).

FIGS. 8A and 8B are views showing a display according to a modification example of the present invention.

### DESCRIPTION OF THE PREFERRED EMBODIMENTS

(Configuration of Display)

A description will be given of the configuration of a display according to an embodiment of the present invention with reference to drawings.

Note that the same or similar reference symbols are allocated to the same or similar parts in the following description of the drawings. However, the drawings are schematic, and it should be noted that the ratio of each dimension is different from that of an actual one. Therefore, a specific dimensions and the like should be judged in consideration of the following description. In addition, parts, whose relations of the dimensions and ratios are different from each other in between the drawings, are naturally included.

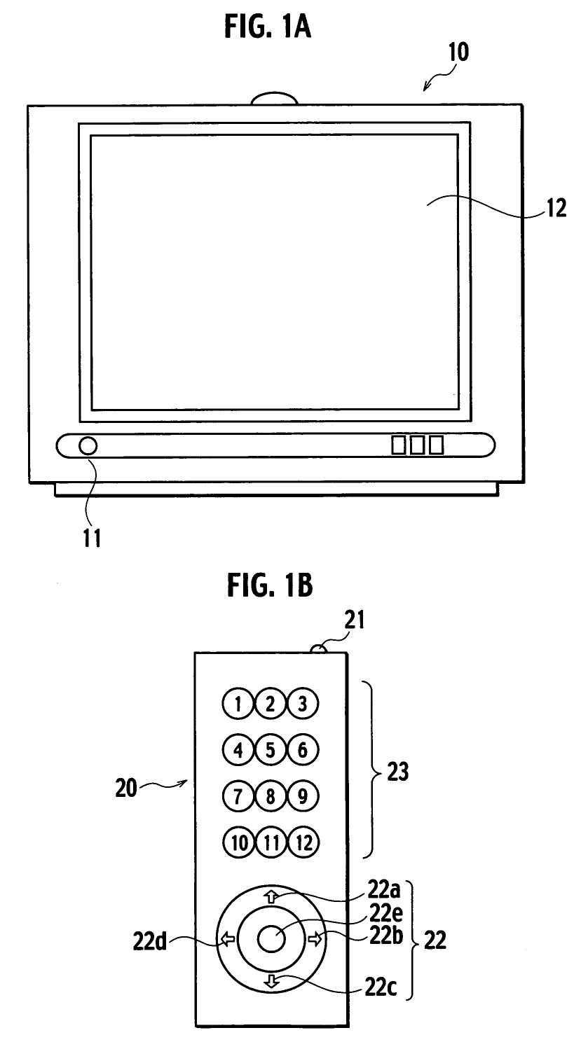

FIGS. 1A and 1B are views showing the display according to the embodiment of the present invention. Note that in the embodiment, the display is a WebTV having a function of playing video contents delivered from a broadcasting station together with a function of displaying a Web page.

As shown in FIGS. 1A and 1B, the WebTV is configured of a WebTV main unit 10 and a remote controller 20.

As shown in FIG. 1A, the WebTV main unit 10 includes a remote side receiver 11 for receiving a signal transmitted by the remote controller 20 and a display unit 12 on which video contents and a Web page are displayed.

Here, the Web page refers to a page displayed based on information received from a network side (for example, HTML information generated in accordance with HTML and XML information generated in accordance with XML). Further, the Web page includes a plurality of link information in which other Web pages are set as a linked page, and is divided into a plurality of areas.

Note that the areas are classified into an active area (any one of the plurality of areas) which is an area in a state that a user can select (an active state) and inactive areas which are the other areas in a state that the user cannot select. Hereinafter, a mode in which the active area can be switched is referred to as the area mode.

Further, the link information is classified into active link information (any one of the plurality of pieces of the link information) which is link information in a state that the user can select (the active state) and inactive link information which is the other pieces of the link information in a state that the user cannot select. Hereinafter, a mode in which the active link information can be switched is referred to as the link mode.

The remote controller 20 includes a transmitter 21 for transmitting a signal to the WebTV main unit 10, a Web operation unit 22 for switching the active area and the active link information when a Web page is displayed, and a TV operation unit 23 for switching broadcasting channels (or video contents delivered from broadcasting stations).

The Web operation unit 22 is configured of an up button 22a, a right button 22b, a down button 22c, a left button 22d and a selection button 22e. Specifically, the up button 22a to the left button 22d are used for switching the active area in the area mode, and for switching the active link information in the link mode. Additionally, the selection button 22e is used for selecting (determining) the active area in the area mode, and for selecting (determining) the active link information in the link mode.

Note that when the active area is selected in the area mode, a mode is switched to the link mode for selecting link information included in the active area, and when the active link information is selected in the link mode, the display contents displayed on the display unit 12 is switched to linked pages (another Web pages) corresponding to the active link information.

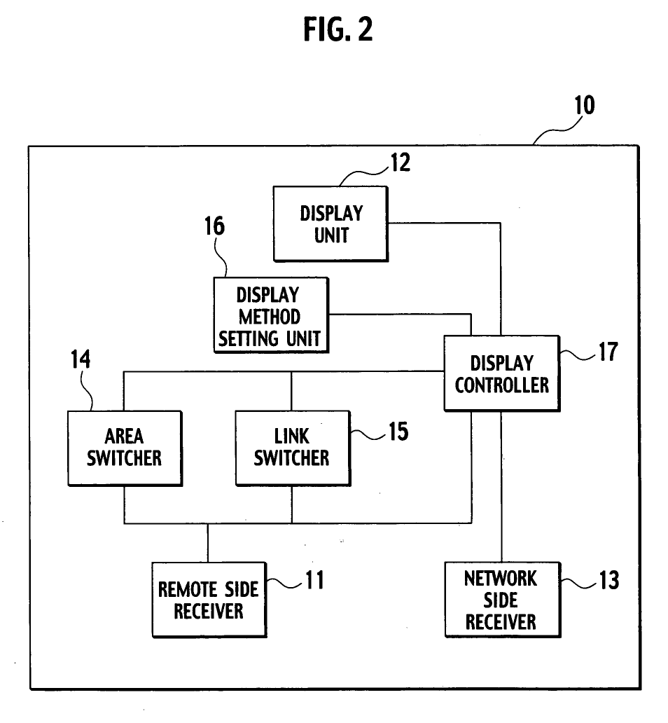

FIG. 2 is a functional block diagram of the WebTV main unit 10.

As shown in FIG. 2, the WebTV main unit 10 includes the remote side receiver 11, the display unit 12, a network side receiver 13, an area switcher 14, a link switcher 15, a display method setting unit 16 and a display controller 17.

The remote side receiver 11 receives a signal corresponding to the operated button from the remote controller 20, when the user operates the Web operation unit 22 and the TV operation unit 23.

Video contents and a Web page are displayed on the display unit 12 as described above.

The network side receiver 13 receives information for displaying video contents delivered from a broadcasting station and Web pages (for example, the HTML and XML information).

The area switcher 14 outputs to the display controller 17 an area switching command for switching the active area in accordance with a signal received from the remote controller 20 (an area switching signal). For example, when receiving an area switching signal corresponding to the up button 22a in the area mode, the area switcher 14 outputs an area switching command for setting an area above the current active area to be an active area. When receiving an area switching signal corresponding to the down button 22c in the area mode, the area switcher 14 outputs an area switching command for setting an area below the current active area to be an active area.

Further, when receiving a mode switching signal corresponding to the selection button 22e in the area mode, the area switcher 14 outputs to a display controller 17 a mode switching command for switching modes to the link mode which is a mode for selecting the link information included in the active area.

The link switcher 15 (a link information switcher) outputs to the display controller 17 a link information switching command for switching the active link information in accordance with a signal (a link information switching signal) received from the remote controller 20. For example, when receiving a link information switching signal corresponding to the up button 22a in the link mode, the link switcher 15 outputs a link information switching command for setting link information above the link information in the active state to be active link information. When receiving a link information switching signal corresponding to the down button 22c in the link mode, the link switcher 15 outputs a link information switching command for setting link information below the link information in the active state to be active link information.

Moreover, when receiving a Web page switching signal corresponding to the selection button 22e in the link mode, the link switcher 15 outputs to the display controller 17 a Web page switching command for switching Web pages to linked pages (Web pages) corresponding to the active link information.

The display method setting unit 16 sets a display method of a Web page in accordance with a condition to be selected by the user. Additionally, the display method setting unit 16 notifies the display controller 17 of the set display method of the Web page. Note that the display method setting unit 16 offers conditions concerning the display methods of a Web page to the user as selections, and sets the display method of the Web page based on the selection to be selected by the user.

Specifically, the display method setting unit 16 sets the size of an area, the number of areas and the shape of an area based on the size, the number and shape to be selected by the user.

The display method setting unit 16 sets the first mode (an initial mode) when receiving information for displaying a Web page. For example, when the area mode is selected as the initial mode by the user, the display method setting unit 16 sets the area mode as the initial mode. On the other hand, when the link mode is selected as the initial mode by the user, the display method setting unit 16 sets the link mode as the initial mode.

The display method setting unit 16 sets the first active area (an initial active area) while the area mode. For example, the display method setting unit 16 sets an area which satisfies a condition (for example, leftmost and topmost) to be selected by the user as the initial active area.

The display method setting unit 16 sets the first active link information (initial active link information) while the link mode. For example, the display method setting unit 16 sets link information which satisfies a condition (for example, topmost) to be selected by the user as the initial active link information.

The display method setting unit 16 sets a display method to be selected by the user as a display method of the area or link information. For example, in a display method, in which the background color of the active area is blue, the background color of the inactive areas are white, is selected, the display method setting unit 16 sets the background colors of the active and inactive areas to blue and white, respectively. Further, when a display method of displaying the active link information in a boldface is selected, the display method setting unit 16 sets the active link information in a bolder type than the inactive link information. Further, when a display method of highlighting only link information corresponding to an image is selected, the display method setting unit 16 sets the display method to highlight the link information corresponding to the image.

The display method setting unit 16 sets a switching method to be selected by the user as a method of switching the active area and the active link information. For example, when a speed to switch the active area and the active link information, an area switching command and a link information switching command are continuously inputted, the display method setting unit 16 sets the speed of switching the active area and the active link information and the like.

The display controller 17 displays received video contents and a Web page on the display unit 12, based on received information (information for displaying the Web page). Note that the display controller 17 displays the Web page in accordance with a display method of the Web page on the display unit 12, which is notified from the display method setting unit 16.

Specifically, the display controller 17 controls the display unit 12 to display the Web page, while dividing the Web page into the plurality of areas, based on the information for displaying the Web page.

Further, the display controller 17 controls the display unit 12 to display link information differently from general information (information having no linked pages) using different colors, and/or underlining the link information.

For example, when receiving the HTML and XML information, the display controller 17 identifies the link information and the general information, by analyzing tag information included in the HTML and XML information. Further, the display controller 17 rewrites the tag information (including a color, a font and the presence of an underline) corresponding to the link information, thus displaying the link information distinguishably from the general information.

The display controller 17 controls the display unit 12 to display the active area in a different color from that of the inactive area, or displays by encircling the active area with a thick line. Thus, the display controller 17 displays the active area distinguishably from the inactive areas on the display unit 12. The display controller 17 controls the display unit 12 to display the active link information in a different color from that of the inactive link information, or displays the active link information in boldface. Thus, the display controller 17 displays the active link information distinguishably from the inactive link information on the display unit 12.

The display controller 17 switches the active link information based on an area switching command input from the area switcher 14, and switches the active link information based on a link information switching command input from the link switcher 15.

Further, the display controller 17 switches modes from the area mode to the link mode based on the area switching command input from the area switcher 14 and notifies the area switcher 14 and the link switcher 15 that the mode has been switched.

The display controller 17 requests the network side for information for displaying a Web page corresponding to the active link information based on a Web page switching command input from the link switcher 15, and displays the Web page corresponding to the active link information based on information received from the network side.

For example, when a Web page is generated based on the HTML or XML information, the display controller 17 identifies the URL and the like of the Web page corresponding to the active link information by analyzing the tag information of the active link information. In addition, the display controller 17 requests the network side for the information for displaying the Web page corresponding to the active link information based on the identified URL and the like.

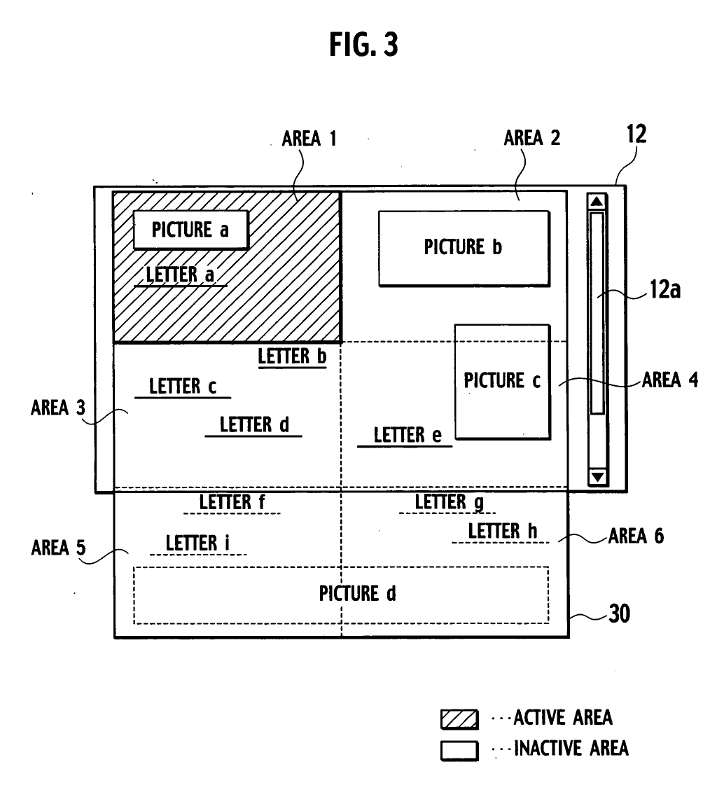

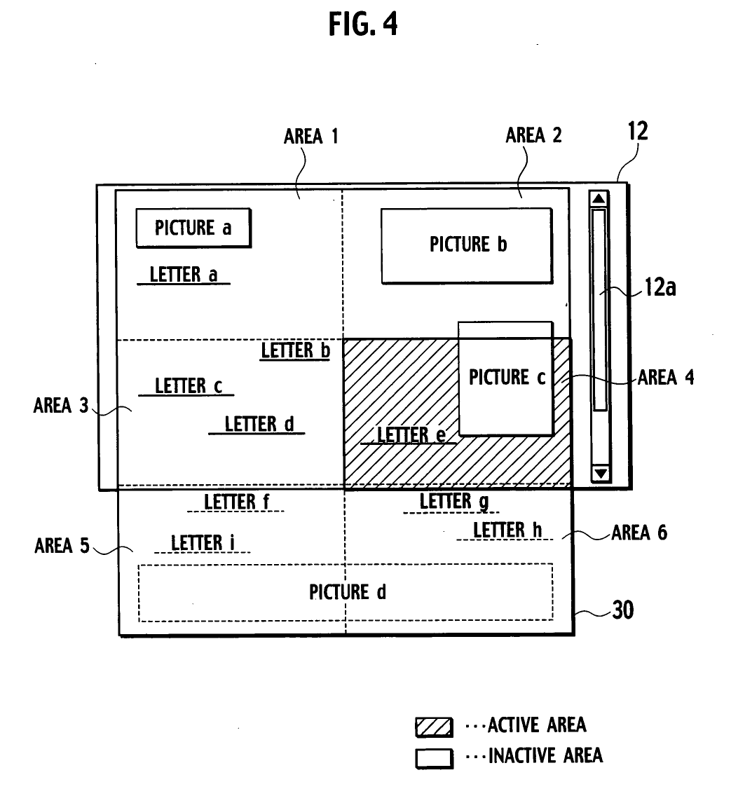

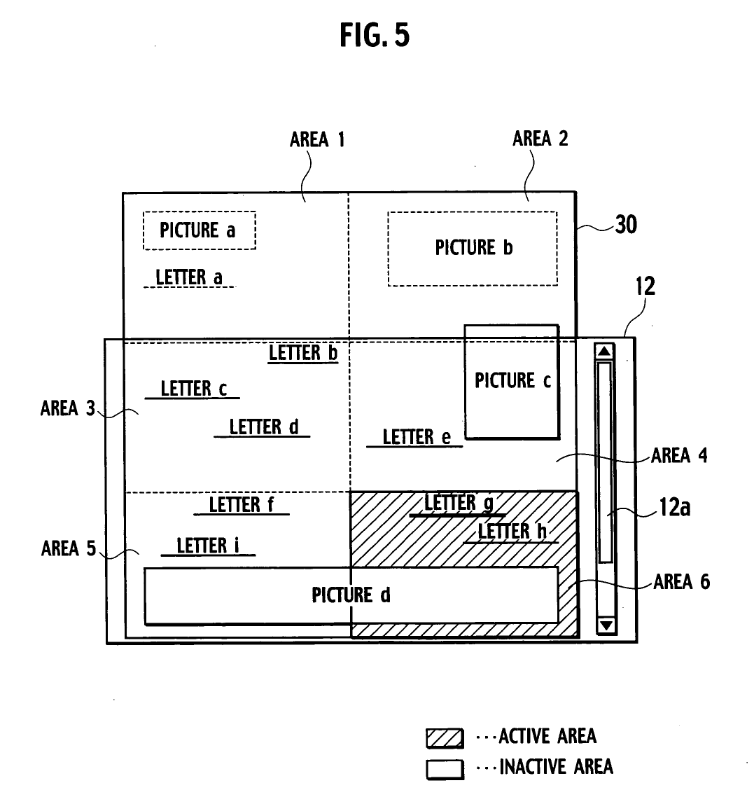

FIGS. 3 to 5 are views showing an example of a Web page displayed on the display unit 12 according to the embodiment of the present invention. Note that FIGS. 3 and 4 are views showing an example of the Web page displayed in the area mode. FIG. 5 is a view showing an example of the Web page displayed in the link mode.

As shown in FIG. 3, a Web page 30 includes link information (“LETTER a” to “LETTER i” and “PICTURE a” to “PICTURE d”) in which other Web pages are set as the linked page, and is divided into a plurality of areas (areas 1 to 6). Since the size of the Web page 30 is larger than that of the display unit 12, only a part (areas 1 to 4) of the Web page 30 is displayed on the display unit 12 (areas 5 and 6 are not displayed on the display unit 12).

Note that there is a part (areas 5 to 6) of the Web page 30, which is not displayed on the display unit 12, and a scroll bar 12a, which indicates that the Web page 30 can be scrolled, is displayed on the display unit 12. Further, the boundaries of each area are displayed on the display unit 12.

The display controller 17 controls the display unit 12 to display the Web page 30 based on the received HTML information. Further, the display controller 17 displays the Web page 30 divided into the plurality of areas (areas 1 to 6) on the display unit 12 as described above.

The display controller 17 controls the display unit 12 to display any one of the plurality of areas (area 1 in FIG. 3) as the active area, and to display the other areas (areas 2 to 4) as the inactive areas. Note that the display controller 17 controls the display unit 12 to display the active area distinguishably from the inactive areas as described above.

When receiving the area switching signals corresponding to the up button 22a to the left button 22d, from the remote controller 20 in the state shown in FIG. 3 (the area mode), the display controller 17 switches the active area based on the area switching command input from the area switcher 14.

For example, when receiving the area switching signal corresponding to the right button 22b in the state shown in FIG. 3 (the area mode), the display controller 17 switches the active area from area 1 to area 2 based on the input area switching command. Further, when receiving the area switching signal corresponding to the down button 22c, the display controller 17 switches the active area from area 2 to area 4 based on the input area switching command (see FIG. 4).

When receiving the area switching signal corresponding to the down button 22c in the state shown in FIG. 4 (the area mode), the display controller 17 switches the active area from areas 4 to 6 based on the input area switching command. At this point, the display controller 17 displays areas 3 to 6 on the display unit 12 by scrolling the Web page 30 upward. Note that areas 1 and 2 are excluded from the targets for the display on the display unit 12.

If area 6 is the active area, when receiving the mode switching signal corresponding to the selection button 22e from the remote controller 20, the display controller 17 switches modes from the area mode to the link mode based on the input mode switching command (see FIG. 5).

As shown in FIG. 5, the display controller 17 controls the display unit 12 to display the active link information in a different color from that of the inactive link information, or displays the active link information in boldface. In this manner, the display controller 17 controls the display unit 12 to display the active link information (“LETTER g” in FIG. 5) distinguishably from the inactive link information (“LETTER h” and “PICTURE d” in FIG. 5).

Further, when receiving a Web page switching signal corresponding to the selection button 22e from the remote controller 20 in the state shown in FIG. 5 (the link mode), the display controller 17 switches the display contents displayed on the display unit 12 to the Web page 30 corresponding to “LETTER g”, based on an inputted Web page switching signal.

Specifically, the display controller 17 requests the network side for the information for displaying the Web page 30 based on the URL and the like of the Web page 30 corresponding to “LETTER g”, and displays the Web page 30 corresponding to “LETTER g” based on the information received from the network side.

According to the display (the WebTV main unit 10) of this embodiment, the area switcher 14 and the link switcher 15 output the area switching command and the link information switching command in accordance with a signal received from the remote controller 20. Further, the display controller 17 switches the active area based on the area switching command input from the area switcher 14, and switches the active link information based on the link information switching command input from the link switcher 15.

Therefore, the user can search for the target link information while browsing the Web page 30 by each area in the area mode using the remote controller 20 to switch the active area.

Further, even if the size of the Web page 30 is larger than that of the display unit 12, the display controller 17 scrolls the Web page 30 when the active area is switched (that is, the Web page 30 is scrolled on an area basis). It enables that the user easily scrolls the Web page 30 using the remote controller 20.

Moreover, in comparison with a case of selecting the target link information from the entire Web page 30 without dividing into the areas, the user can easily select the target link information using the remote controller 20 while the link mode and switch the active link information in the active area.

In other words, the user can easily select the target link information even if the user does not use a pointing device such as a mouse.

The display controller 17 controls the display unit 12 to display the active area distinguishably from the areas other than the active area (the inactive areas), which enables the user to easily recognize that which area is in the selectable state. Therefore, the user can easily search for the target link information.

Further, the display controller 17 controls the display unit 12 to display the active link information distinguishably from the link information other than the active link information (the inactive link information). Therefore, the user can easily recognizes that which piece of link information is in the selectable state.

Moreover, the display controller 17 controls the display unit 12 to display the link information in which other Web pages are set as the linked page distinguishably from the general information in which other Web pages are not set as the linked page. Therefore, the user can easily recognize the information in which the linked page is set.

The display method setting unit 16 sets the display methods (including display and switching methods of the active area and the active link information) of the Web page 30 in accordance with a condition selected by the user. It enables that the user to set a display method to users' own taste.

(First Modification)

A description will hereinafter be given of the first modification of the present invention with reference to the drawings. Note that the description will hereinafter be given mainly of different points from the above-mentioned embodiment.

Specifically, in the above-mentioned embodiment, a Web page is equally divided into a plurality of areas in accordance with the number of areas set by a display method setting unit 16. However, in this modification, a Web page is divided into the plurality of areas based on the attributes of link information.

More specifically, the display controller 17 identifies the attributes of the link information in the Web page based on information received from the network side, thus dividing the Web page 30 into the plurality of areas based on the identified attributes.

For example, when receiving the HTML or XML information from the network side, the display controller 17 identifies the link information in which other Web pages are set and the general information in which other Web pages are not set, based on the tag information included in the HTML or XML information. Further, the display controller 17 identifies the attributes of the link information (including the position of the link information, the type of the link information, and the type of a tag), based on tag information corresponding to the link information.

The display controller 17 divides the Web page 30 in a manner of including, pieces of the link information whose positions are close to each other in the Web page 30 in one area. Further, the display controller 17 divides the Web page 30 in a manner of including, the link information of the same type (a LETTER, an image, an moving image, and the like) in one area. Moreover, the display controller 17 divides the Web page 30 in a manner of including, the link information (for example, each item of a menu list) defined by the same tag in one area.

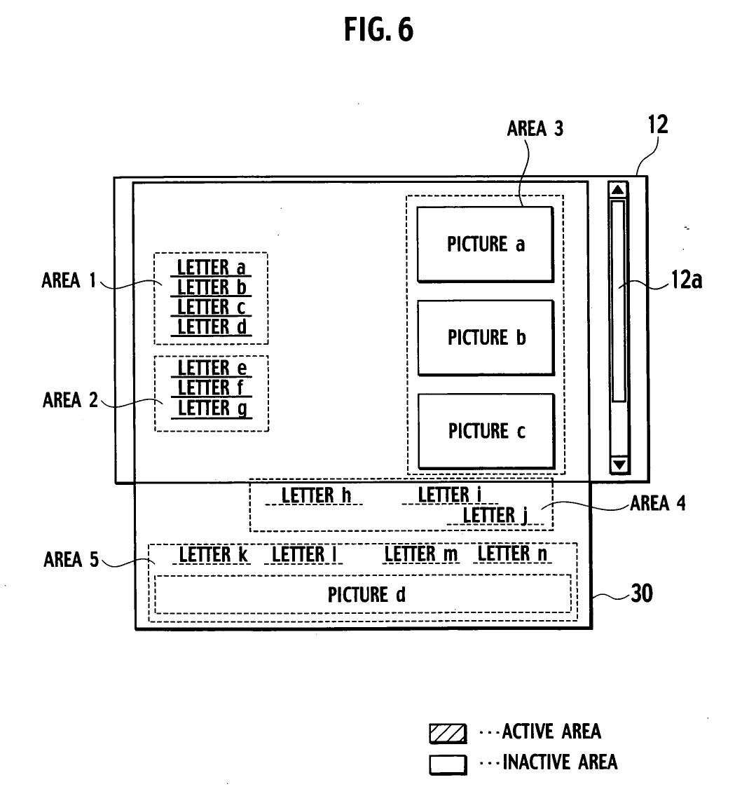

FIG. 6 is a view showing an example of the Web page 30 displayed on the display unit 12 according to the first modification. Note that in FIG. 6, “LETTER a” to “LETTER d” are pieces of link information corresponding respectively to items on a menu list a. Similarly, “LETTER e” to “LETTER g” are pieces of link information corresponding respectively to items on a menu list b which is different from the menu list a. Further, “PICTURE a” to “PICTURE d” are pieces of link information corresponding to images. Moreover, “LETTER h” to “LETTER j” are pieces of link information whose positions are close to each other in the Web page 30. Similarly, “LETTER k” to “LETTER n” and “PICTURE d” are pieces of link information whose positions are close to each other in the Web page 30.

As shown in FIG. 6, the Web page 30 is divided into: area 1 including pieces of the link information corresponding to the menu list a (“LETTER a” to “LETTER d”); area 2 including pieces of the link information corresponding to the menu list b (“LETTER e” to “LETTER g”); area 3 including pieces of the link information corresponding to the images (“PICTURE a” to “PICTURE c”); area 4 including pieces of the link information whose positions are close to each other in the Web page 30 (“LETTER h” to “LETTER j”); and area 5 including pieces of the link information whose positions are close to each other in the Web page 30 (“LETTER k” to “LETTER n” and “PICTURE d”).

Note that although “PICTURE d” is a piece of the link information corresponding to the image, it is included in the same area as “LETTER k” to “LETTER n” (area 5), since its location in the Web page 30 is away from “PICTURE a” to “PICTURE c” and is close to “LETTER k” to “LETTER n”.

According to the display (the WebTV main unit 10 and the remote controller 20) of this modification, the display controller 17 divides the Web page 30 into the plurality of areas based on the attributes of the link information in the Web page 30. It enables to display the Web page 30 which is more efficiently divided into the plurality of areas.

(Second Modification)

A description will hereinafter be given of the second modification of the present invention with reference to the drawings. Note that the description will hereinafter be given mainly of different points of the above-mentioned embodiment.

Specifically, although the areas are configured of one layer in the above-mentioned embodiment, the areas are configured of a plurality of layers in this modification.

More specifically, the display controller 17 identifies the attributes of the link information and general information included in a Web page based on information received from the network side, and displays the Web page 30 divided into a first layer area and a second layer area based on the identified attributes of the link information and general information.

For example, when receiving the HTML or XML information from the network side, the display controller 17 identifies link information in which other Web pages 30 are set and general information in which other Web pages 30 are not set, based on the tag information included in the HTML or XML information. The display controller 17 controls the display unit 12 to display the Web page 30, which is divided into the first and second layer areas, based on the tag information corresponding to the link information and the general information.

The display controller 17 divides the Web page 30 in a manner that the link information or general information defined by specific tag information (for example, “title” showing the heading of a specific genre) is included in the first layer area. Then, the display controller 17 divides the Web page 30 in a manner that link information which can be associated with the link information or general information defined by the specific tag information is included in the second layer area. Note that the display controller 17 may divide the Web page 30 into the plurality of first layer areas or may divide the Web page 30 into the plurality of second layers.

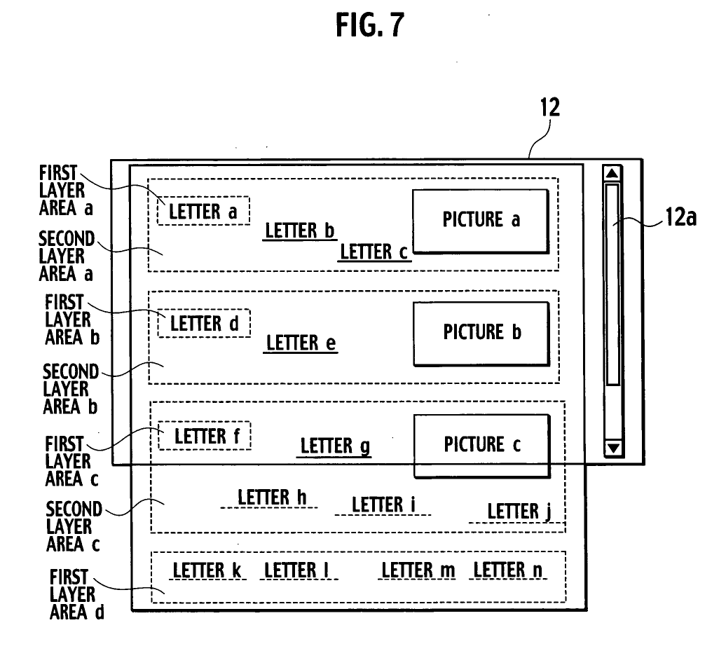

FIG. 7 is a view showing an example of the Web page displayed on the display unit 12 according to the second modification. Note that “LETTER a”, “LETTER d” and “LETTER f” are pieces of the general information (or the link information) defined by the specific tag information (for example, “title” showing the heading of the specific genre).

“LETTER b”, “LETTER c” and “PICTURE a” are pieces of the link information which can be associated with “LETTER a” (the link information pertaining to the same genre as “LETTER a”). “LETTER e” and “PICTURE b” are pieces of the link information which can be associated with “LETTER d” (the link information pertaining to the same genre as “LETTER d”). “LETTER g” to “LETTER j” and “PICTURE c” are pieces of the link information which can be associated with “LETTER f” (the link information pertaining to the same genre as “LETTER f”). Further, “LETTER k” to “LETTER n” are pieces of link information which are irrelevant to “LETTER a”, “LETTER d” and “LETTER f”.

As shown in FIG. 7, the Web page 30 is divided into the first layer area including “LETTER a”, “LETTER d” and “LETTER f” and into the second layer area including “LETTER b”, “LETTER c”, “PICTURE a”, “LETTER e”, “PICTURE b”, “LETTER g” to “LETTER j” and “PICTURE c”

Note that although “LETTER k” to “LETTER n” may be included in the first or second layer area, they are included in the first layer area in this modification.

The first layer area consists of a first layer area a including “LETTER a”, a first layer area b including “LETTER d”, a first layer area c including “LETTER f” and a first layer area d including “LETTER k” to “LETTER n”. That is, the first layer areas are arranged in the Web page 30 at intervals.

The second layer area consists of a second layer area a including “LETTER b”, “LETTER c” and “PICTURE a”, a second layer area b including “LETTER e” and “PICTURE b”, and a second layer area c including “LETTER g” to “LETTER j” and “PICTURE c”.

Hereinafter, the first layer area in a state where the user can select (the active state) is referred to as the active first layer area, and the second layer area in a state where the user can select (the active state) is referred to as the active second layer area. Further, a mode in which the active first layer area can be selected is referred to as the first layer area mode, and a mode in which the active second layer area can be selected is referred to as the second layer area mode.

Note that the display controller 17 switches modes from the first layer area mode to the second layer area mode (or the link mode) by selecting the first layer area (the active first layer area) in the first layer area mode.

For example, if the first layer area a is the active first layer area, when receiving a mode switching signal corresponding to the above-mentioned selection button 22e from the remote controller 20, the display controller 17 switches mode from the first layer area mode to second layer area mode. However, in this modification, the second layer area corresponding to the first layer area a is the second layer area a only. Therefore, the display controller 17 switches modes directly to the link mode in which the link information (“LETTER b”, “LETTER c” and “PICTURE a”) is selectable in the second layer area a without switching to the second area mode.

Note that when there are a plurality of second layer areas which can be associated with the first layer areas, the display controller 17 may switch to the second layer area mode for selecting the active second layer area.

According to the display (the WebTV main unit 10 and the remote controller 20) of this modification, the display controller 17 divides the Web page 30 into the areas (the first and second layer areas) consisted of the plurality of layers. It enables to reduce the number of information included in the Web page 30 (the link information and general information) on a step-by-step basis. The user can easily browse the entire Web page 30 by switching the active first layer areas using the remote controller 20.

(Third Modification)

A description will hereinafter be given of the third modification the present invention with reference to the drawings. Note that the description will hereinafter be given mainly of different points from the above-mentioned embodiment.

Specifically, in the above-mentioned embodiment, the display is a WebTV having a function of playing video contents delivered from a broadcasting station and a function of displaying a Web page. However, in this modification example, a display is installed in a cell phone or a PDA terminal having a function of displaying a Web page.

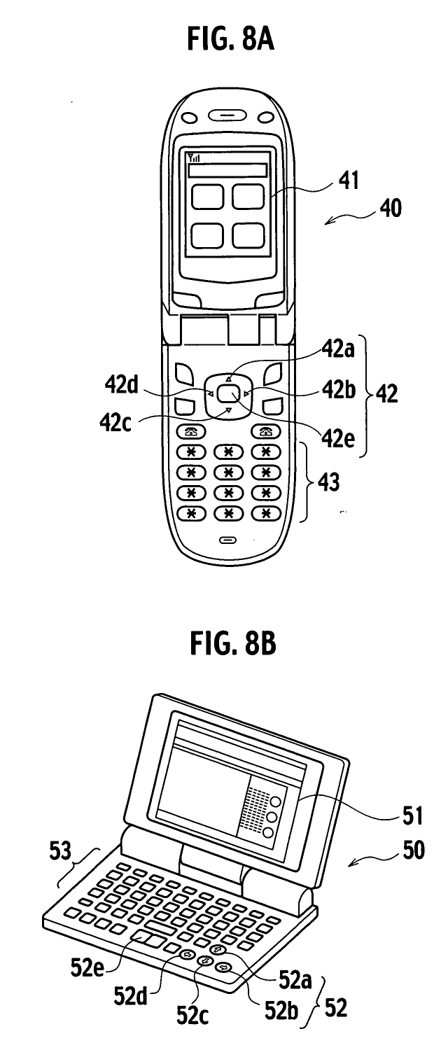

FIG. 8A is a view showing a cell phone 40 according to this modification. FIG. 8B is a view showing a PDA terminal 50 according to this modification.

As shown in FIG. 8A, the cell phone 40 includes a display unit 41 corresponding to the above-mentioned display unit 12, a Web operation unit 42 corresponding to the above-mentioned Web operation unit 22 and a phone operation unit 43 for inputting the phone number of a destination and the like. Further, the Web operation unit 42 consists of an up button 42a to a left button 42d and a selection button 42e corresponding to the above-mentioned up button 22a to left button 22d and selection button 22e.

As shown in FIG. 8B, the PDA terminal 50 includes a display unit 51 corresponding to the above-mentioned display unit 12, a Web operation unit 52 corresponding to the above-mentioned Web operation unit 22 and a data input unit 53 for inputting data and the like. Further, the Web operation unit 52 consists of an up button 52a to a left button 52d and a selection button 52e corresponding to the above-mentioned up button 22a to left button 22d and selection button 22e.

(Other Modifications)

Note that although the boundaries of each area and the scroll bar 12a are displayed on the display unit 12 in the above-mentioned embodiment, the present invention is not limited to this, and the boundaries of each area and the scroll bar 12a may not be displayed.

Although all link information included in the Web page 30 is distinguishably displayed on the display unit 12 from general information according to the above-mentioned embodiment, the present invention is not limited to this, and only link information included in the active area may be displayed distinguishably from general information.

Although the Web operation unit 22 is provided on the remote controller 20 in the above-mentioned embodiment, the present invention is not limited to this, and the Web operation unit 22 may be provided on the WebTV main unit 10.

Although a displayed page which is divided into the plurality of areas is a Web page based on information received from the network side in the above-mentioned embodiment, the present invention is not limited to this. It is sufficient if a page includes pieces of link information in which a linked page is set. Therefore, the display according to the present invention may display a page based on information which is previously stored, such as an electronic dictionary.

Although the remote controller 20 includes the Web operation unit 22 for switching the active area, the active link information and the like in the above-mentioned embodiment, the present invention is not limited to this. The TV operation unit 23 may be caused to have the function of the Web operation unit 22 together with its own function. For example, in the area mode and link mode, the TV operation unit 23 may be configured to: cause a button for selecting a broadcasting channel 2 to function as the up button 22a; cause a button for selecting a broadcasting channel 6 to function as the right button 22b; cause a button for selecting a broadcasting channel 8 to function as the down button 22c; cause a button for selecting a broadcasting channel 4 to function as the left button 22d; and cause a button for selecting a broadcasting channel 5 to function as the selection button 22e.

Although modes are switched from the area mode to the link mode in the above-mentioned embodiment, the present invention is not limited to this. Modes may be switchable from the link mode to the area mode by causing the Web operation unit 22 to have a button for switching modes from the link mode to the area mode.

As described above, although the detailed description was given of the present invention with the examples, it is obvious to those skilled in the art that the present invention is not limited to the examples described in this application. The display and the display program of the present invention may be embodied as corrected and modified aspects without departing from the spirit and scope of the present invention specified in the description of the scope of claims. Therefore, the application is described for the purpose of the exemplificative explanation, and is not intended to impose any limitation on the present invention.

What is claimed is:

1. a display comprising:
a display controller configured to display a page including a plurality of link information in which a linked page is set and which is divided into a plurality of areas on a predetermined viewing area;
an area switcher configured to switch an active area, which is the area in a state where a user can select, based on an area switching signal; and
a link information switcher configured to switch an active link information, which is the link information in a state where the user can select in the active area, based on a link information switching signal.

2. The display of claim 1, wherein the display controller displays the page divided into the plurality of areas based on the attributes of the link information in the page.

3. The display of claim 1, wherein the display controller displays the active area distinguishably from the areas other than the active area.

4. The display of claim 1, wherein the display controller displays the active link information distinguishably from the link information other than the active link information.

5. The display of claim 1, wherein the display controller displays the link information distinguishably from a general information in which a linked page is not set.

6. The display of claim 1, further comprising a display method setting unit configured to set a display method of the page.

7. The display of claim 1, wherein the area includes a first layer area, and a second layer area which is associated with the first layer area.

8. A display program causing a computer to execute the steps of:
displaying a page including a plurality of link information in which a link page is set and which is divided into a plurality of areas on a predetermined viewing area;
switching an active area, which is the area in a state where a user can select, based on an area switching signal; and
switching an active link information which is the link information in a state where the user can select in the active area, based on a link information switching signal.

9. The display program of claim 8, wherein the computer is caused to execute a step of dividing the page into the plurality of areas based on attributes of the link information in the page.
